(19) United States
(12) Patent Application Publication
(10) Pub. No.: US 2009/0265733 A1
(43) Pub. Date: Oct. 22, 2009

(54) METHOD AND APPARATUS FOR PROVIDING TARGETED ADVERTISING DURING THE PRESENTATION OF SDV PROGRAMMING

(75) Inventor: Mark McKelvey, Wayne, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/105,791

(22) Filed: Apr. 18, 2008

(51) Int. Cl. H04N 7/10

(52) U.S. Cl. 725/32

(57) ABSTRACT

A method is provided for delivering a targeted advertisement to a user who is viewing a switched digital video (SDV) program. The method includes receiving over an access network a user input reflective of the user's advertising preferences. An advertisement is selected at least in part on the user input that is received. During a commercial break in transmission of a program to the user over the access network, the advertisement is transmitted to the user over the access network on an SDV channel.

### FIELD OF THE INVENTION

The present invention relates generally to a switched digital video system for distributing content to a subscriber over a system such as a satellite or cable television system, and more particularly to a switched digital video system in which advertising can be targeted to subscribers by selecting an advertisement based on user advertising preferences.

### BACKGROUND OF THE INVENTION

Switched digital video (SDV) refers to an arrangement in which broadcast channels are only switched onto the network when they are requested by one or more subscribers, thereby allowing system operators to save bandwidth over their distribution network. In conventional cable or satellite broadcast systems, every broadcast channel is always available to all authorized subscribers. In contrast, a switched digital video channel is only available when requested by one or more authorized subscribers. Also, unlike video on-demand, which switches a singlecast interactive program to a user, switched digital video switches broadcast streams, making each stream available to one or more subscribers who simply join the broadcast stream just as they would with normal broadcast services. That is, once a switched service is streamed to a subscriber, subsequent subscribers associated with the same service group as the first subscriber can tune to the same broadcast stream. The switched digital video will often share the same resource managers and underlying resources with other on-demand services.

As noted, switched digital video is largely a tool to save bandwidth. From the subscriber perspective, he or she still receives the same broadcast video service when using a switched broadcast technique; ideally the user is not able to discern that the stream was switched at all. If each one of the digital broadcast channels is being watched by subscribers in the same service group, the switched digital video approach does not yield any bandwidth savings. However, a more likely situation statistically is that only a certain number of the digital broadcast channels are being watched by subscribers in the same service group at any given time. Those channels not requested by a subscriber need not be broadcast, thereby saving bandwidth.

One way to support switched digital video is to utilize a session manager to manage SDV sessions and provision services. The subscriber's receiver (e.g., a set-top terminal) will request an SDV program from the session manager. The session manager will determine if the requested channel is already being sent to the corresponding service group that the subscriber belongs to. The subscriber receiver will be assigned to join the existing SDV service if the requested channel is available at the service group or assigned to a new SDV service if the requested channel is not available at the service group. The Session Manager will negotiate with the edge devices to allocate resources required for the service. The edge device (e.g., a digital modulator such as a QAM modulator) needs to dynamically retrieve the MPEG single program transport stream that carries the requested broadcast program (likely via IP unicast or multicast) and generate the MPEG multiple program transport stream. As part of the service setup response message, the video tuning parameters such as frequency and MPEG program number are sent back to the subscriber to access the requested broadcast channel.

As with other types of broadcast programming, advertising forms an important part of SDV programming. The revenues generated from advertisers subsidize and in some cases pay entirely for the programming. Even in subscriber-based television systems such as cable and satellite television systems, the revenues from advertisements subsidize the cost of the programming, and were it not for advertisements, the monthly subscription rates in such systems could be many times higher than at present.

Traditional broadcast television systems broadcast the same television signal to each person viewing a particular station. Thus, each person viewing a particular channel will necessarily view the same programming content as well as the same advertisements embedded in the programming content. However, with modern digital television systems such as SDV systems more personalized television service is possible. For instance, in SDV systems, a group of subscriber households can be selectively addressed through a cable node serving that group. Similarly, individual subscriber households can be selectively addressed though their set top terminals. In other words, the service provider can send different data to different subscribers or groups of subscribers.

Typically, a particular advertiser will purchase a particular “spot”, i.e., an advertising opportunity in a particular channel at a particular time, based on the likelihood that members of that advertiser's target audience will be watching that particular channel at that particular time. For instance, advertisers typically have a particular demographic group of individuals that they wish to reach with their advertising. For example, the manufacturer of a low-cost beer probably has a primary target audience of males between the ages of 21 and 39, living in households with a household annual income of less than $75,000 per year. As another example, a manufacturer of laundry detergent may have a primary target audience of women between 19-59 years of age with no particular preference regarding household income. In yet another example, a manufacturer of expensive beer may wish to have a target audience similar to that of the manufacturer of low-cost beer in that it comprises males between the ages of 21 and 39. However, this manufacturer's target demographic audience may include a different economic profile, e.g., males between the ages of 21 and 39, living in households with annual household incomes of over $60,000 per year. Another advertiser that manufactures children's toys appropriate for children between 5 and 10 years of age might have a target audience of children between the ages of 5 and 10 and, depending upon the particular toys, a desired annual household income range.

The selective addressability of modern digital television service systems renders more targeted TV advertising possible. As a result, demographic data may be used to provide different subscribers of the same television program different advertisements that are particularly directed to them. In order to effectively target advertising to subscribers it is necessary to understand certain attributes of the target subscriber, such as demographic and psychograph attributes, and to acquire any data relevant to determining the appropriateness of an advertisement for the particular subscriber. Such data can include past viewing habits and previous purchasing selections and the like.

Despite the use of demographic data to more precisely target advertising to subscribers, subscribers will often still avoid viewing television advertisements. Television advertisements may be avoided in a number of ways including, for example, by switching television channels during an advertisement or by recording a television program and then using trick mode functionality to skip recorded advertisements. One reason why a viewer may avoid viewing an advertisement is because the viewer may not be interested in the product or service being advertised. Advertisement avoidance results in lower advertisement exposure for advertisers and, therefore, in lower potential revenue for television service providers. Therefore, there is a need for systems and methods for increasing the viewing of television advertisements.

### BRIEF DESCRIPTION OF THE DRAWINGS

FIG. 1 shows one example of a system architecture for delivering switched digital video content to a subscriber.

FIG. 2 shows one example of a headend that can be used to deliver SDV programming to target groups of subscribers.

FIG. 3a illustrates the headend transmitting the primary advertisement and the alternative advertisements in the same transport stream and FIG. 3b illustrates the headend transmitting the primary advertisement and the alternative advertisements in separate transport streams.

FIG. 4 shows one example of a set top terminal.

FIG. 5 shows an example of an advertisement category selection screen which may be provided in response to user input.

FIG. 6 show an example of an advertisement sub-category selection screen which may be provided in response to the selection of an advertisement category via the advertisement category selection screen depicted in FIG. 5.

FIG. 7 shows an example of an advertisement source selection screen which may be provided in response to the selection of an advertisement sub-category via the advertisement sub-category selection screen depicted in FIG. 6.

FIG. 8 shows an example of a product preference selection screen which may be provided in response to the selection of an advertisement source option via the advertisement source selection screen depicted in FIG. 7.

FIG. 9 is flowchart showing one example of method by which the headend delivers a targeted advertisement to a user who is viewing an SDV or a non-SDV program.

### DETAILED DESCRIPTION

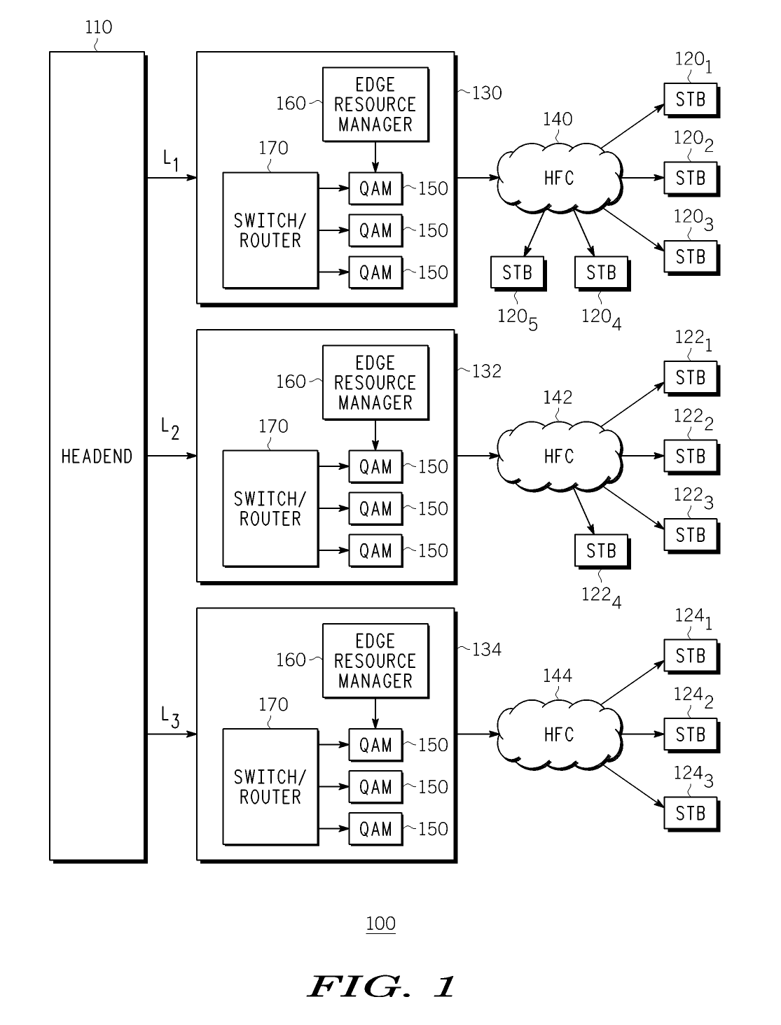

As detailed below, a higher rate of advertising viewership can be achieved by allowing the user to choose the particular types of advertisements, or even the advertisements themselves, that are of interest to him or her. In addition, the subscriber may be provided with an incentive to make the selection, either at the time the selection is made and/or at the time the advertisement is actually viewed. The advertisements may be delivered to the individual subscribers on a switched digital channel, which will be described below in the context of the system architecture shown in FIG. 1.

FIG. 1 is a system architecture 100 for delivering switched digital channels to a subscriber during a switched digital video (SDV) session. The SDV session is implemented through a service offering in which application level data generated by a set-top terminal initiates a SDV session request and an SDV manager routes data in accordance with the request to provision the service. Among other components, system architecture 100 comprises a content source such as a headend 110 that is connected to multiple intermediate entities such as hubs 130, 132 and 134. The headend 110 communicates with a switch or router 170 in hubs 130, 132 and 134 over links L1, L2 and L3, respectively. The headend 110 and hubs 130, 132 and 134 may communicate over a packet-switched network such as a cable data network, passive optical network (PON) or the like using, for example, IP multicast or unicast addressing. Details concerning multicast and unicast addressing as they pertain to targeted advertising will be presented below. As used herein, advertising refers to any content that interrupts the primary content that is of interest to the viewer. Accordingly, advertising can include but is not limited to, content supplied by a sponsor, the service provider, or any other party, which is intended to inform the viewer about a product or service. For instance, public service announcements, station identifiers and the like are also referred to as advertising.

Some or even all of the hubs are connected to multiple users, typically via distribution networks such as local cable access networks (e.g., HFC networks). For simplicity of explanation only, each hub is shown as being connected to a distinct HFC network, which in turn communicates with end user equipment as illustrated. In particular hubs 130, 132 and 134 in FIG. 1 communicate with access networks 140, 142 and 144, respectively. Each access network 140, 142 and 144 in turn communicates with multiple end user devices such as set top terminals. In the example of FIG. 1, access network 140 communicates with set top terminals 120₁, 120₂, 120₃, 120₄ and 120₅, access network 142 communicates with set top terminals 122₁, 122₂, 122₃ and 124₄, and access network 144 communicates with set top terminals 124₁, 124₂ and 124₃.

In addition to the switch or router 170, each hub can include an array of radio frequency transmitter edge devices such as edge QAM modulators 150. The number of edge devices 150 in each hub may vary as needs dictate. As used herein, the term “QAM” refers to modulation schemes used for sending signals over cable access networks. Such modulation schemes might use any constellation level (e.g. QAM-16, QAM-64, QAM-256 etc.) depending on the details of a cable access network. A QAM may also refer to a physical channel modulated according to such schemes. Typically, a single QAM modulator can output a multiplex of ten or twelve programs, although the actual number will be dictated by a number of factors, including the communication standard that is employed. The edge QAM modulators usually are adapted to: (i) receive Ethernet frames that encapsulate the transport packets, (ii) de-capsulate these frames and remove network jitter, and (iii) transmit radio frequency signals representative of the transport stream packets to end users, over the HFC network. Each transport stream is mapped to a downstream QAM channel. Each QAM channel has a carrier frequency that differs from the carrier frequency of the other channels. The transport streams are mapped according to a channel plan designed by a system operator that operates the network.

Each hub 130, 132 and 134 also includes an edge resource manager 160 for allocating and managing the resources of the edge devices 150. The edge resource manager 160 communicates with and receives instructions from the session manager located in the headend 110.

When a viewer selects an SDV channel using a subscriber terminal such as a set top terminal, the SDV system actively switches the channel onto one of the QAMs that serves that particular set top terminal. The set top terminals are generally arranged into service groups and each of the service groups is assigned to, and serviced by, one or more QAM modulators. For example, in the arrangement depicted in FIG. 1 set top terminals 120₁, 120₂, 120₃, 120₄ and 120₅ are assigned to QAM modulators 150 located at hub 130, set top terminals 122₁, 122₂, 122₃ and 122₄ are assigned to QAM modulators 150 located at hub 132, and set top terminals 124₁, 124₂ and 124₃ are assigned to QAM modulators 150 located at hub 134. Typically, four (4) or eight (8) QAM modulators are deployed per service group to carry the SDV channels. SDV service groups currently include from about 500 to 1000 set top terminals. Depending on the system topology, there may or may not be a one-to-one correspondence between the hubs and the service groups. For instance, it is typically the case that each hub serves multiple service groups.

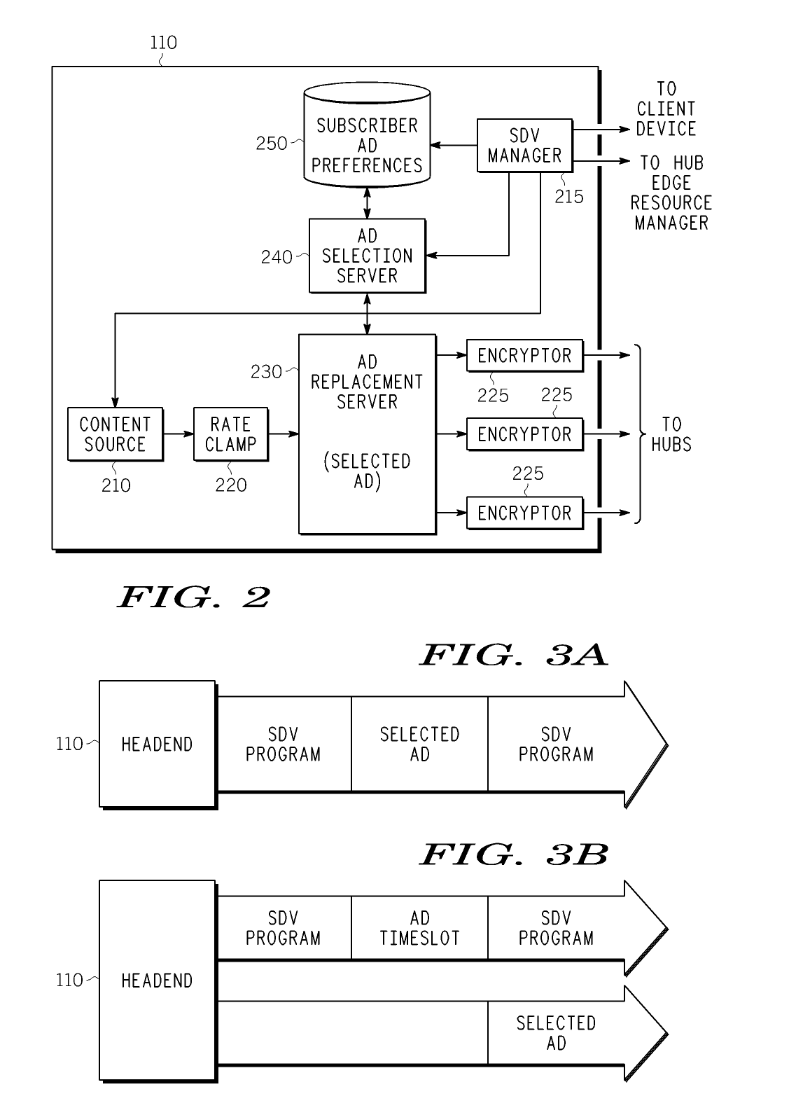

FIG. 2 shows one example of headend 110. The headend 110 includes a broadcast content source 210, which may include, by way of example, satellite receivers, off-air receivers and/or content storage devices such as servers. An SDV manager 215 is used to determine which SDV transport streams are being transmitted by the headend at any time and for directing the set top terminals to the appropriate stream. The SDV manager 215 also keeps track of which subscribers are watching which channels and it communicates with the edge resource managers 160 (see FIG. 1) in the hubs so that the content can be switched on and off under the control of the SDV manager 215. In addition, all subscriber requests for a switched digital channel go through the SDV manager 215. Content is forwarded by the content source to a rate clamp 220, an ad replacement server 230 that inserts the appropriate advertisements into their respective timeslots, and one or more optional encryptors 225. In this example the content is then encrypted by the encryptors 225 and transmitted to the appropriate hub or hubs using, for instance, multicast addressing. Typically, standard definition (SD) channels are currently rate clamped to 3.75 Mbps while high definition channels are currently rate clamped to between about 12 Mbps and 15 Mbps. The encryptors 225 encrypt the digitally encoded content, often under the control of a conditional access system (not shown). As discussed in more detail below, the ad replacement server 230 inserts the advertisements under the direction of an ad selection server 240, which in turn makes its determinations based on information received from the SDV manager 215 and a subscriber advertising preferences database 250.

It should be noted that the headend 110 shown in FIG. 2 may also include a variety of other components for offering additional services. For example, the headend 110 may comprise typical headend components and services including a billing module, a video-on-demand (VOD) server, a subscriber management system (SMS) or billing module, a conditional access system and a LAN(s) for placing the various components in data communication with one another. Also, although not shown, one of ordinary skill in the art would recognize that other components and arrangements for achieving the various functionalities of headend 110 are possible. It will also be appreciated that the headend configurations depicted in FIG. 2 is a high-level, conceptual architecture and that each system may have multiple headends deployed using different architectures.

Enhanced targeting of advertisements to subscribers can be accomplished by presenting the subscriber's set top terminal with an advertisement that corresponds to an advertisement or type of advertisement that is selected by the subscriber. An advertisement or type of advertisement may be selected by a subscriber significantly in advance (e.g., an hour, a day, a week, a month, or a year in advance) and/or immediately prior to the presentation of a corresponding advertisement. Furthermore, an advertisement selection screen may be provided to a user in response to user input and/or during a scheduled advertisement interruption in a television broadcast presentation. Returning to the headend shown in FIG. 2, in one example this enhanced advertising feature can be implemented with use of the ad replacement server 230, ad selection server 240 and the subscriber ad preferences database 250.

The subscriber ad preferences database 250 stores the preference information obtained from the subscribers concerning the types of ads they are most interested in viewing. The data located in the database 250 is based on user input, which can be acquired, for instance, using questionnaires and the like that are presented to the subscriber via the subscriber's set top terminal. The ad replacement server 230 is pre-loaded with candidate advertisements that can be inserted at the appropriate points in the programming. Multiple advertisements may be available for each advertising timeslot in the programming. When a program is being delivered to a particular subscriber, the ad selection server 240 chooses the most appropriate advertisement to be inserted into each advertising timeslot of the program stream based at least in part on the preference information pertaining to that subscriber, which is available from the subscriber ad preferences database 250. The selected advertisement can be inserted directly into the program stream by the ad replacement server 230.

FIG. 3a illustrates an arrangement in which the headend 110 transmits a transport stream that includes the SDV program and the selected ad. FIG. 3b, on the other hand, shows an arrangement in which the headend 110 transmits a program stream that includes the SDV program and a timeslot in which the selected ad is to be inserted. The selected advertisements are transmitted in a separate transport stream or service. The arrangement shown in FIG. 3a is particularly suitable when the SDV programming is being delivered to only a single subscriber such as when the program is being unicast, for example. The arrangement shown in FIG. 3b is particularly suitable when the SDV programming is being sent to multiple subscribers such as when the program is being multicast, for example. If multicasting is employed, the arrangement is FIG. 3b still allows ads to be targeted to individual subscribers even while the programming is being received by multiple subscribers.

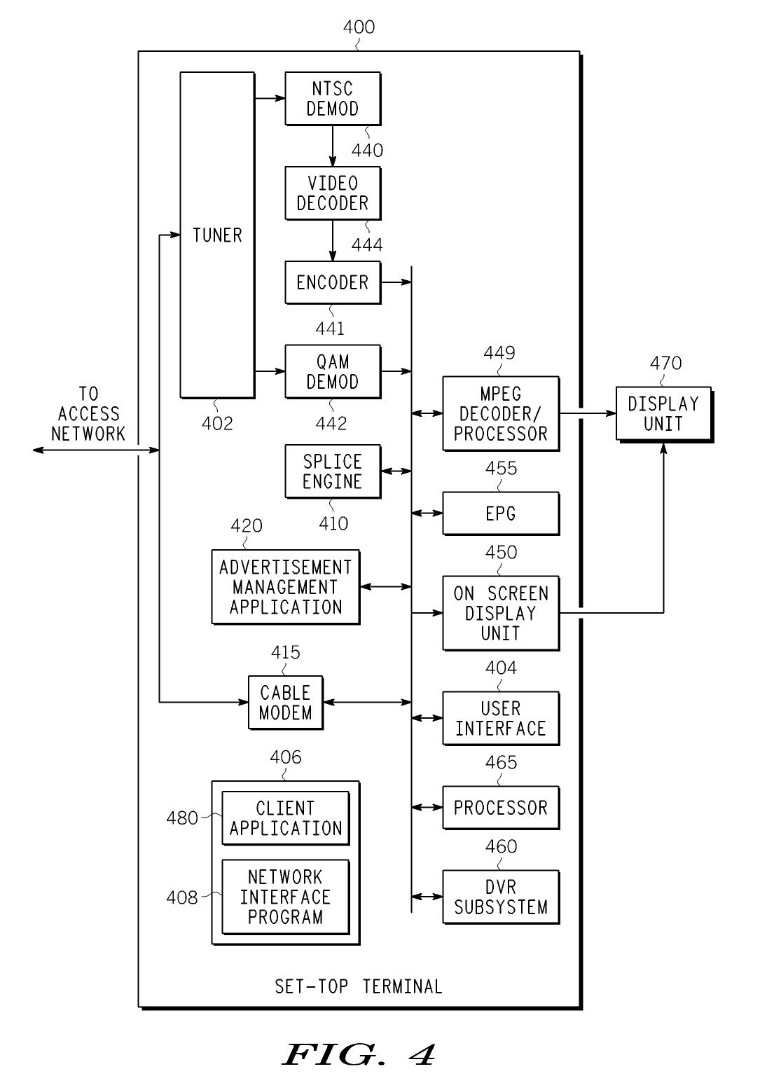

One example of a set top terminal 400 is shown in more detail in FIG. 4. It should be noted that set top terminal 400 more generally may be any apparatus such as a hardware card, specially programmed computer or other device having the functionality described herein that may be placed near to or within a television or other display device (such as a computer monitor) such as display unit 470. The set top terminal 400 receives content from cable access networks seen in FIG. 1. Broadly speaking, a traditional set top terminal such as that depicted in FIG. 4 is a device that can receive, store and forward content without manipulating the content in any significant way except to format it so that it may be rendered in a suitable manner.

Set-top terminal 400 includes an in-band tuner 402, which tunes to a channel selected by the subscriber via user interface 404. While not shown, a second in-band tuner may be provided, which could, for example, be used to receive the advertisements when they are transmitted on a separate transport stream. User interface 404 may be any control device such as a remote control, mouse, microphone, keyboard, or display. NTSC demodulator 440 and digital demodulator 442 are responsive to in-band tuner 402. NTSC demodulator 440 includes components responsive to receive analog versions of a channel signal. A digital demodulator 442, which as shown is a QAM demodulator, but, which may be any type of digital demodulator device, includes components responsive to receive digital versions of a channel signal, and to output video information. QAM demodulator 442 receives and processes digital data packets from one or more digital sources, such as a digital television signal, an MPEG transport stream, or a media stream from an external network connection, such as cable modem 415 (if available), using well-known methods and techniques. Video decoder 444 is responsive to receive and decode video information.

Video information that may require format translation or modification for compatibility with capabilities of set top terminal 400 may be passed to encoder 441 for formatting. Video information that is in a format preferred for use by MPEG Decoder/Multi Media Processor 449 may be passed directly to MPEG Decoder/Multi Media Processor 449. Encoder 441 is operative to perform predetermined coding techniques (for example, MPEG-2, MPEG-4, and others) to produce an encoded video signal for transmission to MPEG Decoder/Multi Media Processor 449, or for storage. MPEG Decoder/Multi-Media Processor 449 is operative to perform predetermined coding techniques to arrange video information into displayable formats, in accordance with well-known methods and techniques. Internal arrangements of MPEG Decoder/Multi-Media Processor 449 are well known, and may include analog-to-digital converters, one or more storage media and/or buffers, and general or special-purpose processors or application-specific integrated circuits, along with demultiplexers for demultiplexing and/or synchronizing at least two transport streams (for example, video and audio).

Splice engine 410 may be employed when the advertisements are made available on a separate transport stream from the programming, such as shown in FIG. 3b, for example. The splice engine 410 may implement any appropriate splicing process. Since the programs and commercials are typically digitally encoded data streams (e.g., MPEG-2 data streams), the set top terminal should preferably be configured to support digitally encoded data stream splicing without converting the data stream to the analog domain. In the context of MPEG-2, for instance, at the appropriate time the SDV manager can instruct the set top terminal to insert the particular commercial by specifying the PID of the advertisement. The SDV manager can send the PIDs in the same manner it sends other control information to the set top terminals using either in-band or out-of-band channels.

An electronic program guide (EPG) 455 is also provided in set top terminal 400. The EPG 455 displays information analogous to TV listings found in local newspapers or other print media. An EPG provides information about each program being broadcast within the time period covered by the EPG, which typically ranges from the next hour up to several days. The information contained in an EPG includes programming characteristics such as, for example, channel number, program title, start time, end time, elapsed time, time remaining, a brief description of the program's content and possibly the names of individuals associated with the program such as the actors, writers and director. The EPG, which is generally received along with the programming content, may be updated on a periodic basis so that the consumer can make appropriate selection for upcoming programs. For example, the electronic program guide 455 may display programs in a tabular format by channel and time so that the user can make selections of desired content. In some cases, instead of transmitting it along with the programming, the electronic program guide 455 may be downloaded via a telephone line, cable connection, satellite up-link, down-link, or radio broadcast antenna.

The set top terminal 400 also includes an advertisement management application 420, which is an interactive, on-screen display feature that acquires advertising preferences from the subscriber and communicates them to the headend 110 for storage in subscriber preferences database 250. The advertisement management application 420 presents the subscriber with menus from which the preferences selections can be made, some examples of which will be shown below. In some cases advertisement management application 420 may be preloaded with the various menus. Alternatively, the advertisement management application 420 may receive the menus and other necessary information in the form of files, software objects and the like from the headend 110. Updates may be provided to the advertisement management application 420 in this manner as well. The advertisement management application 420 may also serve as a repository such as a buffer for the subscriber's responses until they are forwarded to the headend 110.

An on-screen display unit 450 is provided in set top terminal 400. The on-screen display unit 450 is used to display information such as control menus and the like as well as information received from the service provider or MSO that needs to be directly presented to the user regardless of the particular programming or channel that the user is currently viewing. In particular, on-screen display unit 450 displays the information provided by the advertisement management application 420. Accordingly, on-screen display unit 450 can forward the information directly to the display unit 470, where it may replace the current programming that appears on the display unit 470. Alternatively, the information may appear as an overlay, pop up, or scrolling text ticker that is superimposed on the current programming being viewed, possibly using a blending or overlay circuit that may be associated with the on-screen display unit 450.

DVR subsystem 460 is provided for recording programs received from the access network. DVR subsystem 460 can control the channel tuned by tuner 402 and record programming on a manual or timer control basis. Additionally, the DVR subsystem 460 can buffer incoming programs to enable a view to pause or replay a portion of a live program.

Set-top terminal 400 further includes a computer-readable storage medium 406. Computer-readable storage medium 406 may be any local or remote device capable of recording or storing data, and in particular may be, or may include, a read only memory (“ROM”), flash memory, random access memory, a hard disk drive, all types of compact disks and digital videodisks, and/or magnetic tape. Various application programs may reside on storage medium 406. The applications residing on storage medium 406 may be computer programs that include software components implemented according to well-known software engineering practices for component-based software development and stored in computer-readable memories, such as storage medium 406. The applications, however, may be any signal processing methods and/or stored instructions, in one or more parts, that electronically control functions set forth herein. Storage medium 406 may also include other programs to provide additional functionality. For example, a network interface program 408 may be provided that represents aspects of the functional arrangement of various computer programs that pertain to the receipt and processing of content and other data over a broadband system.

The various components of set top terminal 400 discussed above may all operate under the overall control of a processor 465. Moreover, it is contemplated that the processor 465, tuner 402, video decoder 449, user interface 404, onscreen display unit 450, splice engine 410, advertisement management application 420 and the other components shown in FIG. 4 may each be implemented in hardware, software or a combination thereof. In addition, although the various components are shown as separate processors, it is contemplated that they may be combined and implemented as separate processes on one or more processors.

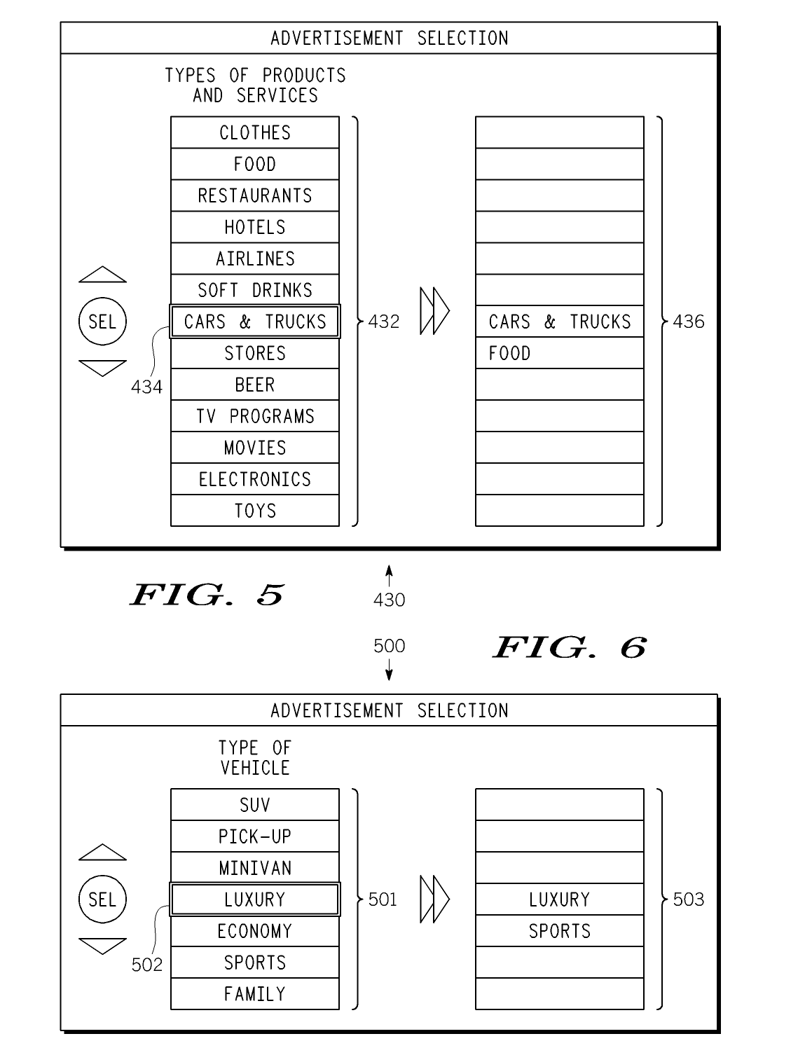

FIGS. 5-8 depict some examples of screens that are presented to the subscriber by the advertisement management application 420 for selecting an advertisement or type of advertisement. The screens can be used to obtain a profile of the subscriber's advertising preference, which can be stored in the subscriber ad preferences database 250. Different users in the same residence may each have their own profile stored in the database 250. Of course, those of ordinary skill in the art will recognize that additional, different, and/or fewer selection screens may be used in an alternative implementations. The various screens and menus may be presented in response to receipt of a user input such as, for example, the activation of an appropriate key or button on a remote control unit. Of course, the user input may be received by other input devices, including, for example, a keyboard device, a mouse, a voice activated input system, a touch-screen display and the like. The subscriber's responses may be sent to the database 250 in near real-time or, alternatively, they may be buffered in the set top terminal 400 and sent at a later time.

FIG. 5 depicts an example of an advertisement category selection screen 430 that includes an advertisement category menu 432 having advertising category options corresponding to categories of products and services that may be advertised during breaks in programming. Advertising category options may include, for example, clothes, food, restaurants, hotels, airlines, soft drinks, cars & trucks, stores, beer, TV programs, movies, electronics, baby products, and toys (among others). In another implementations, the advertisement category selection menu 432 may contain fewer, additional, or different advertisement category options such as, for example, make-up, kitchen products, household products, furniture, health products, and VOD movies, etc. The advertisement category options may be used to determine user preferences regarding advertisements. The user input may be used to highlight an option or to access additional options by scrolling up or down the advertisement category menu. An advertisement category option that is selected from the television advertisement category menu is added to an active selection list 436. After the user selects the desired advertisement categories, the user can provide additional input in order to confirm the selections. In some cases, instead of selecting individual category options, the options may be ranked with a numerical score to indicate the categories that most interesting and least interesting to the user.

FIG. 6 shows an example of an advertisement sub-category selection screen 500 which may be provided, in one example, in response to the selection of an advertisement category via the advertisement category selection screen 430 of FIG. 5. An advertisement sub-category menu 501 includes advertising sub-category options corresponding to the user selected category which, in this example, is “Cars and Trucks” 434. In some cases, if a user had selected multiple categories via the category selection screen 430, then the sub-category menu may include options corresponding to respective sub-categories. Alternatively, the user may be provided with multiple sub-category menus in succession, where each sub-category menu corresponds to one of the multiple categories that were selected via the category selection screen 430. Advertisement sub-category options may be used to determine user preferences in relation to a specific category of advertisements (e.g., cars and trucks). Advertisement sub-category options corresponding to the cars and trucks category 434 may include, for example, SUV, pick-up, minivan, luxury, economy, sports, and family. A user may provide user input in order to select one or more sub-categories from the sub-category menu 501. A sub-category option that is selected from the menu 501 is added to an active selection list 503.

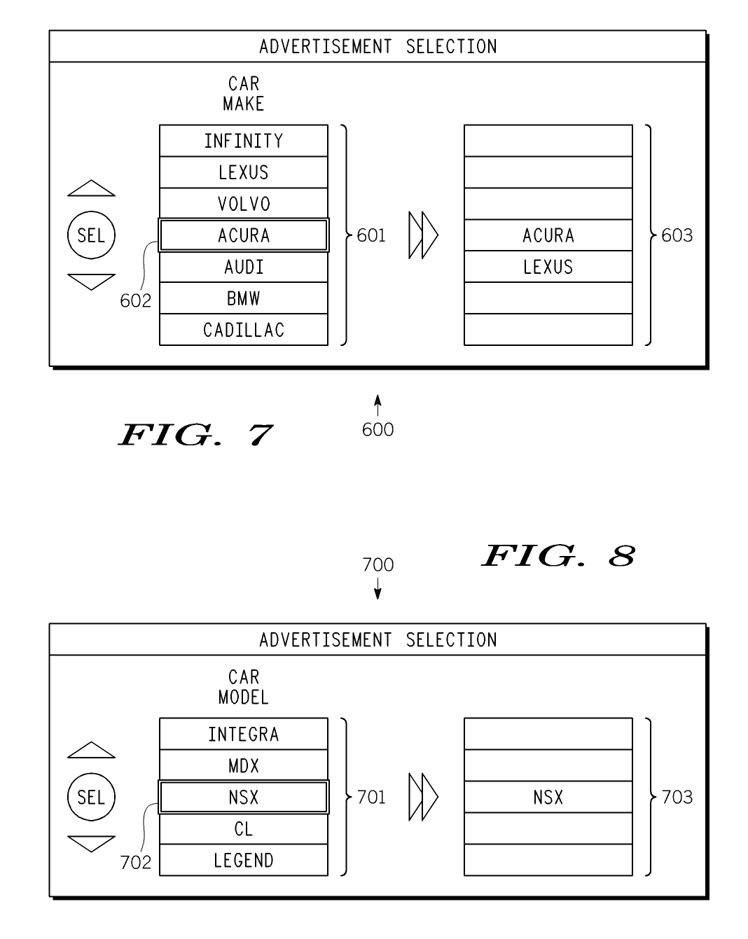

FIG. 7 shows an example of an advertisement source selection screen 600 which may be provided in response to the selection of an advertisement sub-category via the advertisement sub-category selection screen 500 in FIG. 6. In some cases the advertisement source selection screen 600 may be provided directly in response to the selection of the cars and trucks option 434 via the advertisement category selection screen 430 of FIG. 5. An advertisement source menu 601 includes advertising source options corresponding to the user selected sub-category which, in this example, is luxury cars & trucks 502. Advertisement source options may be used to determine user preferences 603 in relation to a source or name-brand for a certain type of products. Advertising source options corresponding to the luxury cars and trucks option 502 may include, for example, Infinity, Lexus, Volvo, Acura, Audi, BMW, and Cadillac, among others.

FIG. 8 shows an example of a product preference selection screen 700 which may be provided in response to the selection of an advertisement source option via the advertisement source selection screen 600 of FIG. 7. A product preference menu 701 includes product preference options corresponding to the user selected advertisement source which, in this example, is Acura 602. Product preference options may be used to determine user preferences in relation to a specific product. Product preference options corresponding to the Acura option 602 may include, for example, the following Acura models: Integra, MDX, NSX, CL, and Legend. In this example the option NSX 702 is selected as user preference 703.

It should be noted the screens and menus shown in FIGS. 5-8 merely represent one way in which user preferences may be elicited from a user. More generally, the arrangements for targeting advertising to users described herein encompass any technique for receiving user preferences. For instance, in some cases the user may even communicate his or her preferences to the subscriber ad preferences database 250 without use of set top terminal. In one example, the user may access a web-based interface using a PC or the like, which interface allows users to directly enter their preferences in a convenient manner.

As previously mentioned, in some cases the subscriber may be provided with an incentive to select the advertisements or types of advertisements that they are most interested in. In some implementations the incentive may take the form of an award of currency, e.g. a cash back rebate or reward points for providing advertising preferences via the subscriber's set top terminal in the manner described above. A cash back rebate may take the form of a rebate from the MSO or other service provider on the cost of their SDV or other content delivery service. If reward points are earned by the subscriber, they may be redeemed to purchase any of a variety of products and services. Of course, other forms of rewards currency may also be issued, such as coupons, certificates and the like. Rewards currency can be assigned each time the subscriber submits an advertising preference. For example, one point may be assigned for every advertising selection that is made from the menus shown in FIGS. 5-8. In other examples, rewards currency may be issued based upon the subscriber meeting a set of pre-defined rules that may include, for instance, the selection of a certain number of advertising preferences over a period of time such as a day, week or month.

In a further attempt to increase advertising viewership, subscriber's may be provided with an incentive not only to select ads or ad types of interest, but also to actually view the ads when they are presented. The incentive can be provided based on user inputs that are received by the set top terminal and forwarded to the headend 110 confirming that the advertisement has been, is being, and/or will be viewed. For instance, at the end of an ad's presentation, the subscriber may be presented with a menu asking one or more questions designed to elicit a response from the subscriber that he or she actually viewed the ad. In many cases the nature of the question(s) and the answer(s) received will be less important than the mere fact that a subscriber provided a response, which at least suggests that he or she was viewing the preceding ad. In other cases, the response to the questions may provide valuable information that can be used, for example, by the MSO and/or the advertiser. Such questions may elicit information rating the quality of the ads, for instance. In any case, the subscriber may receive rewards currency when they respond to questions presented at the end of an ad. This rewards currency may supplement the rewards currency that the subscriber receives when their advertising preferences are received at the headend 110. On the hand, in some cases the rewards currency provided in response to questions presented at the end of an ad may replace the rewards currency that is provided when the subscriber selects his or her advertising preferences. In this way the subscriber must both select ads or types of ads of interest and view the ads before receiving any rewards currency. In some cases the subscriber may be able to use the rewards currency to purchase items that may be made available on menus that can be presented when the subscriber's advertising preferences are obtained.

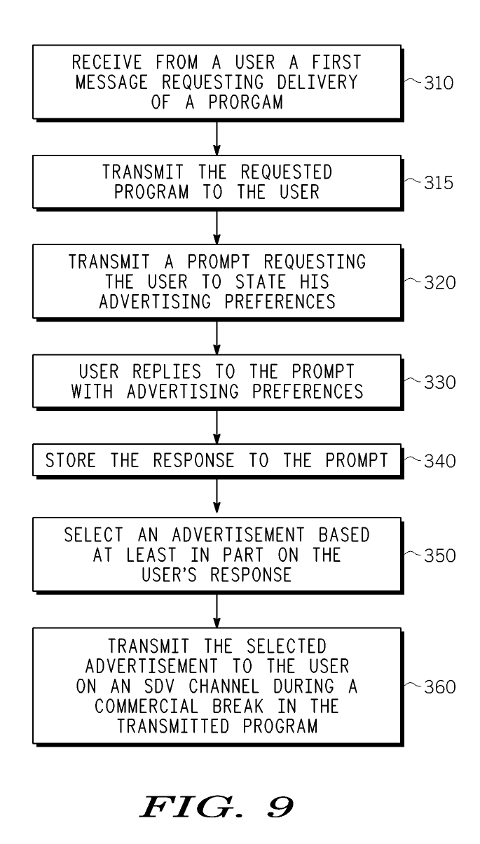

FIG. 9 is flowchart showing one example of method by which the headend delivers a targeted advertisement to a user who is viewing an SDV program. For simplicity, this example assumes that the user is prompted for his or her advertising preferences at the time a program is requested. Of course, the user may be prompted for his or her preferences at any time, and the targeted ads may be delivered during programming that is or is not associated with the prompt and the user's response to the prompt.

The method begins in step 310 when the SDV manager or other suitable entity in the headend receives from a user a first message requesting delivery of a program. Delivery of the requested program to the user over the access network begins at step 315. At a time either before or after the first message is received, a prompt or request is transmitted by the headend in step 320 requesting the user to state his or her advertising preferences. The prompt may be received at any appropriate time, such as when the set top terminal is initialized or first set up upon installation. Alternatively, or in addition, the prompt may be received at subsequent times such as upon user request, for example, or when individual programs are requested, or when a channel is viewed for the first time. As previously noted, the prompt may take any form, including, for instance questionnaires of the type shown in FIGS. 5-8. In step 330 the user sends a second message to the SDV manager replying to the prompt with the user's advertising preferences, which are stored in the subscriber ad preferences database in step 340. Based at least in part on the user's response, the SDV manager selects an appropriate advertisement in step 350. In step 360, the selected advertisement is transmitted to the user on an SDV channel for presentation during a commercial break in the transmitted program. If the selected advertisement and the program are transmitted on separate program streams as in FIG. 3b, the selected advertisement may be transmitted to the set top terminal at any time before it is to be presented.

The processes described above, including but not limited to those presented in connection with the headend and set-top terminal may be implemented in general, multi-purpose or single purpose processors. Such a processor will execute instructions, either at the assembly, compiled or machine-level, to perform that process. Those instructions can be written by one of ordinary skill in the art following the description of presented above and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

1. At least one computer-readable medium encoded with instructions which, when executed by a processor, performs a method including:
receiving over an access network a user input reflective of advertising preferences of the user;
selecting an advertisement at least in part on the user input that is received; and
during a commercial break in transmission of a program to the user over the access network, transmitting the advertisement to the user over the access network on an SDV channel.

2. The computer-readable medium of claim 1 wherein the user input is responsive to a request for advertising preferences.

3. The computer-readable medium of claim 1 wherein the program and the selected advertisement are transmitted in a common transport stream.

4. The computer-readable medium of claim 1 wherein the program and the selected advertisement are transmitted to the user on different transport streams.

5. The computer-readable medium of claim 1 further comprising prompting the user to provide the user input reflective of the advertising preferences of the user.

6. The computer-readable medium of claim 5 wherein the prompt includes causing a questionnaire to be presented to the user concerning advertising preferences and wherein the user input includes a response to at least one question in the questionnaire.

7. The computer-readable medium of claim 6 wherein the questionnaire includes a list of products and/or services from which the user may select to thereby indicate the advertising preferences.

8. The computer-readable medium of claim 7 wherein the questionnaire is transmitted over the access network to a set top terminal for rendering by a display device associated with the set top terminal.

9. The computer-readable medium of claim 1 further comprising incentivizing the user to provide the user input reflective of the advertising preferences of the user.

10. The computer-readable medium of claim 7 further comprising incentivizing the user to provide the user input reflective of the advertising preferences of the user.

11. The computer-readable medium of claim 10 wherein incentivizing includes an awarding of currency in return for user input responsive to the questionnaire.

12. The computer-readable medium of claim 11 wherein the currency is selected from the group consisting of a cash back rebate and reward points.

13. The computer-readable medium of claim 1 further comprising awarding currency to the user after receipt of a second user input indicating that the user has viewed the advertisement.

14. A set top terminal comprising:
a receiver/tuner for receiving SDV programs over a access network;
a user interface for receiving user inputs;
an advertisement management application for (i) receiving a message over the access network which prompts a user to provide user input, via the user interface, which is reflective of advertising preferences of the user and (ii) causing the message to be rendered on a display device; and
a processor operationally associated with the receiver/tuner, the user interface and the advertisement management application.

15. The set top terminal of claim 14 further comprising a splice engine for causing an advertisement received on an SDV channel to be rendered during a commercial break in a program being received on a transport stream distinct from the transport stream on which the advertisement is received.

16. The set top terminal of claim 15 wherein the program is received on a second SDV channel.

17. The set top terminal of claim 15 wherein the program is a non-SDV program.

18. At least one computer-readable medium encoded with instructions which, when executed by a processor, performs a method including:
transmitting a requested program to a user over an access network;
accessing a database to obtain advertising preferences associated with the user;
selecting an advertisement based at least in part on the advertising preferences of the user that are obtained; and
during a commercial break in transmission of the program, transmitting the advertisement to the user over the access network on an SDV channel.

19. The computer-readable medium of claim 18 further comprising: transmitting a prompt to the user requesting user input reflective of the advertising preferences; and storing data obtained from the user input in the database.
